(19) United States
(12) Patent Application Publication
(10) Pub. No.: US 2007/0157187 A1
(43) Pub. Date: Jul. 5, 2007

(54) Process of automatically translating an extended activity diagram into a hardware component graph

(75) Inventors: Fu-Chiung Cheng, Taipei City (TW); Shin-Hway Yu, Taipei City (TW); Kuan-Yu Chen, Taipei City (TW); Jian-Yi Chen, Taipei City (TW); Ming-Shiou Chiang, Taipei City (TW); Shu-Ming Chang, Taipei City (TW); Hung-Chi Wu, Taipei City (TW); Ping-Yun Wang, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/471,483

(22) Filed: Jun. 21, 2006

(30) Foreign Application Priority Data
Dec. 30, 2005 (TW) 094147592

(51) Int. Cl. G06F 9/45; G06F 9/44

(52) U.S. Cl. 717/151; 717/162; 717/144; 717/105

(57) ABSTRACT

A process of automatically translating an extended activity diagram (EAD) into a hardware component graph (HCG). For translating the high level programming language into a Very High Speed Integrated Circuit Hardware Description Language (VHDL), the high level programming language is first translated into an activity diagram (AD), then the AD is translated into an HCG, which can indicate a connection relation between hardware components, and finally corresponding HDL codes are generated according to the HCG

### BACKGROUND OF THE INVENTION

1. Field of the Invention

The invention relates to a process of automatically translating an extended activity diagram (EAD) into a hardware component graph (HCG) and, more particularly, to a process of translating an EAD, which represents an executing flow of a program, into a HCG, which indicates a connection relation between hardware components.

2. Description of Related Art

Typically hardware description languages such as VHDL, Verilog cannot directly describe the programming logic and executing flow of a high-level programming language. Accordingly, the high-level programming language is translated into an activity diagram (AD) defined in a unified modeling language (UML). The AD is a flow description diagram and can represent the programming logic and executing flow of a high-level programming language. However, the AD is not associated with physical hardware components and cannot be translated directly into a hardware description language. Accordingly, the known process cannot translate a high-level programming language directly into a corresponding HDL.

Therefore, it is desirable to provide an improved method to mitigate and/or obviate the aforementioned problems.

### SUMMARY OF THE INVENTION

An object of the invention is to provide a process of automatically translating an extended activity diagram (EAD) into a hardware component graph (HCG), which can translate the EAD into the HCG to thereby benefit subsequent simulation and translation to VHDL.

Another object of the invention is to provide a process of automatically translating an extended activity diagram (EAD) into a hardware component graph (HCG), which can use the HCG to indicate a connection relation between hardware components.

To achieve the objects, the invention is to provide a process of automatically translating an extended activity diagram (EAD) into a hardware component graph (HCG). The EAD consists of plural subgraphs. The process includes: (A) reading a subgraph of the EAD, and executing step (E) when all subgraphs of the EAD is read; (B) directly translating the subgraph of the EAD into a corresponding HCG when the subgraph of the EAD is determined to be a fork, join or merge type, and executing (A); (C) performing a syntax analysis and translation on the subgraph of the EAD when the subgraph of the EAD is determined to be a micro-operation type to thus obtain the corresponding HCG, and executing (A); (D) performing a label analysis first and then a syntax analysis and translation on output ports of obtained corresponding HCGs when the subgraph of the EAD is determined to be a select type, translating the subgraph of the EAD determined to be the select type into the corresponding HCG, and executing step (A); and (E) linking all participant input and output ports between the corresponding HCGs to output a complete HCG.

In the process of automatically translating an extended activity diagram (EAD) into a hardware component graph (HCG), the EAD includes eight nodes of start, end, curve point, micro-operation, fork, join, select and merge.

In the process of automatically translating an extended activity diagram (EAD) into a hardware component graph (HCG), the HCG includes three types of start node, end node and component node.

In the process of automatically translating an extended activity diagram (EAD) into a hardware component graph (HCG), the EAD, a flow control graph, is obtained by modifying an activity diagram defined in a unified modeling language (UML).

Other objects, advantages, and novel features of the invention will become more apparent from the following detailed description when taken in conjunction with the accompanying drawings.

### BRIEF DESCRIPTION OF THE DRAWINGS

FIG. 1 is a graph of an EAD specification of a preferred embodiment of the invention;

FIG. 2A is a graph of a start node of a preferred embodiment of the invention;

FIG. 2B is a graph of an end node of a preferred embodiment of the invention;

FIG. 2C is a graph of component nodes of a preferred embodiment of the invention;

FIG. 2D is a graph of control path nodes of a preferred embodiment of the invention;

FIG. 2E is a graph of data path nodes of a preferred embodiment of the invention;

FIG. 3A is a graph of a micro-operation node and the corresponding HCG of a preferred embodiment of the invention;

FIG. 3B is a graph of a micro-operation node and the corresponding HCG of a preferred embodiment of the invention;

FIG. 3C is a graph of a micro-operation node and the corresponding HCG of a preferred embodiment of the invention;

FIG. 3D is a graph of a select node and the corresponding HCG of a preferred embodiment of the invention;

FIG. 4 is a flowchart of a process of translating an EAD into an HCG according to a preferred embodiment of the invention;

FIG. 5 is a graph of an EAD corresponding to a Java program according to a preferred embodiment of the invention;

FIG. 6 is a graph of an HCG corresponding to an EAD according to a preferred embodiment of the invention.

### DETAILED DESCRIPTION OF THE PREFERRED EMBODIMENT

Since the prior process cannot translate a high level programming language directly into a hardware description language (HDL) such as VHDL and Verilog, the high level programming language, such as Java, C, C++, is first translated into a temporal format called activity diagram (AD) when a user desires to translate the high level programming language into the HDL. An AD is a flow description graph to represent the programming logic and executing flow of a high level programming language, which, in fact, is not associated with physical hardware components. Accordingly, the AD is translated into a hardware component graph (HCG) that is more associated with physical hardware components, such that a corresponding HDL is generated according to the HCG in order to describe the high level programming language.

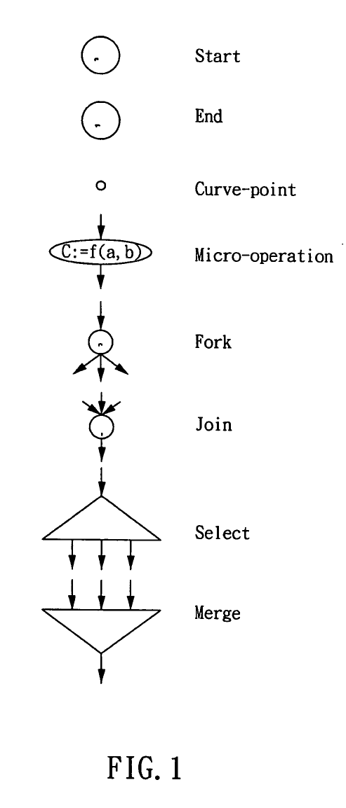

In this embodiment, an AD defined in a unified modeling language (UML) is partially modified. The modified AD is referred to as an extended AD (EAD), which is a flow control graph capable of translating source codes coded by a high level programming language into corresponding flows. A complete EAD consists of plural subgraphs, and each subgraph consists of different nodes. In this embodiment, referring to an EAD specification shown in FIG. 1, the different nodes can be divided into eight types:

1. a start node to indicate a start of a subgraph;

2. an end node to indicate an end of the subgraph;

3. a curve point node to indicate two directional edges for providing a convenience in a translation process, which have no practical affection on an operation;

4. a micro-operation node to indicate a statement or expression processing;

5. a fork node to indicate a parallel operation;

6. a join node to indicate that an output signal is sent only when the outputs of all micro-operations are collected;

7. a select node to indicate selecting an appropriate output signal after decoding; and

8. a merge node to indicate merging all input signals into an output signal to output.

Each node is regarded as an object. A corresponding EAD translated from the source codes is generated by linking each subgraph, which can present the programming logic and executing flow of the source codes in a visualization form.

As cited, the specification used in all subgraphs of the invention is described.

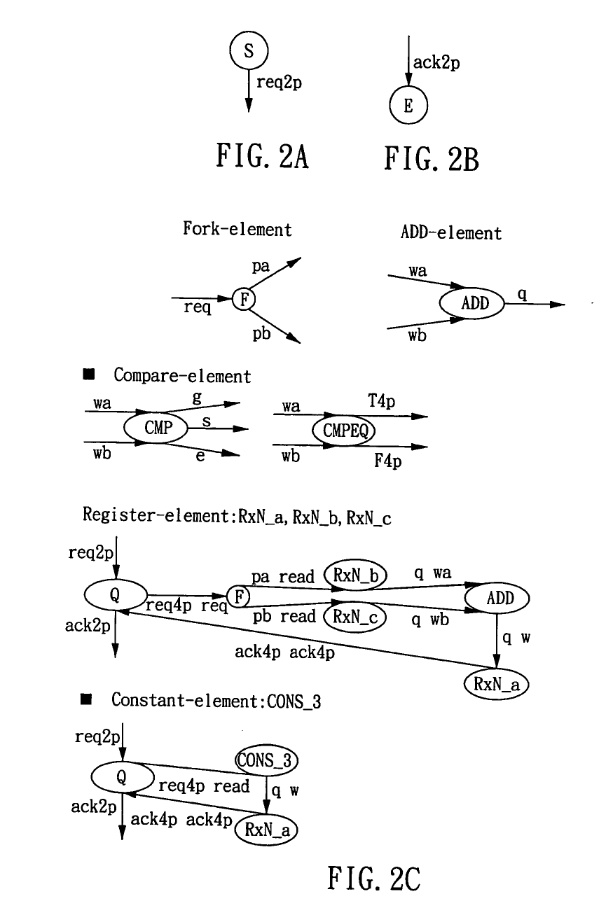

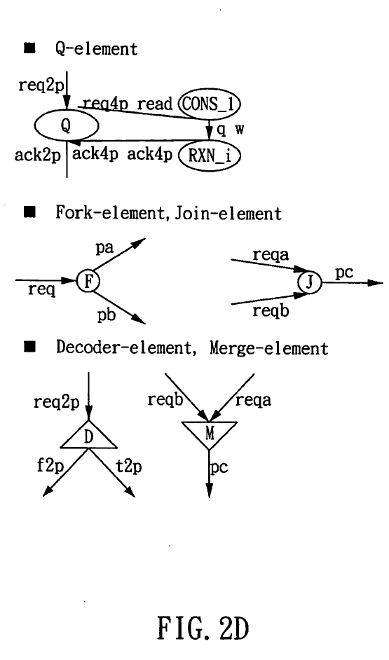

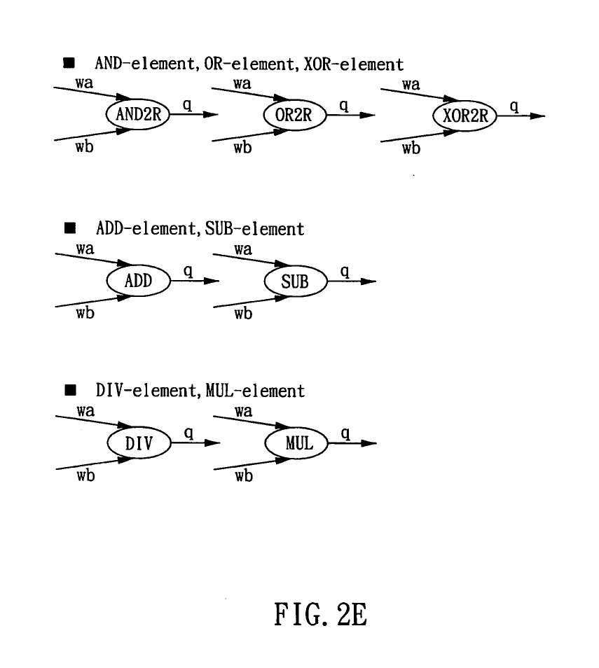

In this embodiment, a complete EAD is translated into a corresponding HCG to indicate a relation between a high level programming language and hardware. As shown in FIGS. 2A to 2C, an HCG includes three types of nodes: start, end and component.

1. The start node shown in FIG. 2A records the information of class name, method name, parameter, local variable, global variable, return type of a Java program, wherein,
i. “M” indicates the information of a method, including method name and its modifiers;
ii. “R” indicates the information of a return value, including return type, bit size and return name;
iii. “P” indicates the information of a parameter, including parameter type, bit size and parameter name; and

iv. “L” indicates the information of a local variable, including local variable type, bit size and local variable name.

2. The end node shown in FIG. 2B indicates that a method is ended, and a variable name to be returned is labeled. When the content of the end node contains a keyword “VOID”, it indicated that no variable is returned.

3. The component nodes shown in FIG. 2C are hardware components labeled register, fork, adder and the like. A directional edge links between the nodes, and a label on each directional edge indicates a link from an output port of a source object to an input port of a target object.

In this embodiment, the component nodes can be further grouped into two part, control path modules and data path modules.

(1) As shown in FIG. 2D, the control path modules include
Q-element (notation “Q”),
fork-element (notation “F”),
join-element (notation “J”),
decoder-element (notation “D”), and
merge-element (notation “M”).

(2) As shown in FIG. 2E, the data path modules include:
arithmetic logic unit. (ALU), containing AND-element, OR-element, XOR-element, ADD-element, SUB-element, MUL-element and DIV-element;
register-element, i.e., RxN-element;
multiplexer and demultiplexer, i.e., RMUXDEMUX-element and WMUXEMUX-element; and
constant, i.e., CONS-element.

In addition, the content of the component node can be represented as follows.

(1) The registers and the constants, which require labels to separate, can be expressed as:
Component name_variable name.

(2) The micro-operation (MICROOP), compare-element (CMP), the merge-element (MERGE) and the like, which do not require labels, can be expressed directly as:

Component name.

In addition, the directional edge between the nodes can be expressed as:
source node output port→target node input port.

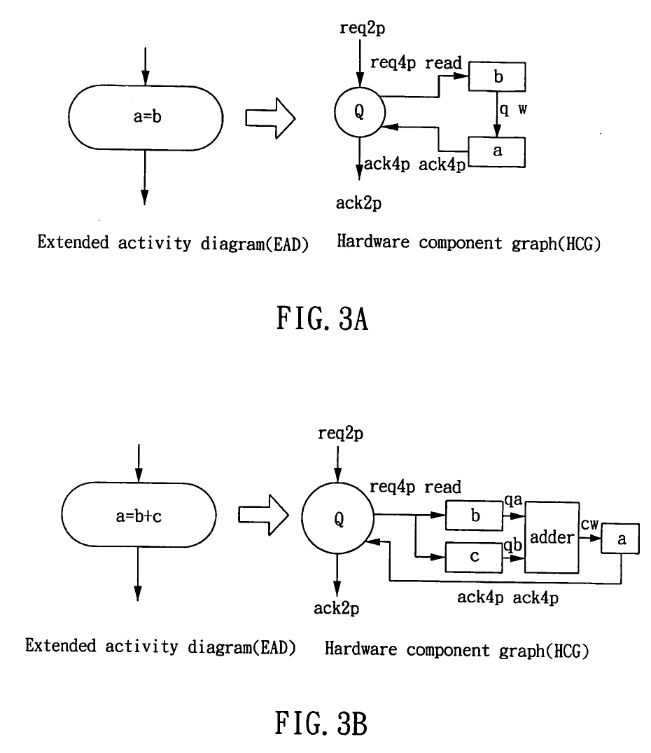

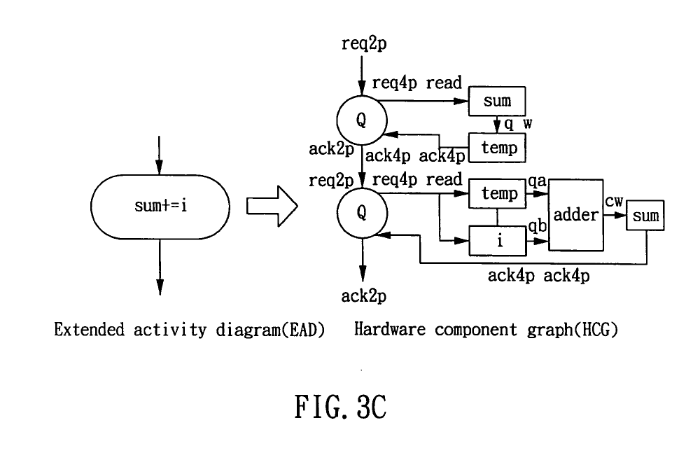

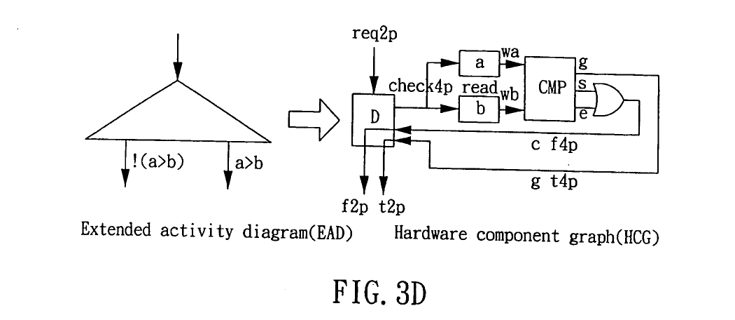

FIG. 3A shows a micro-operation node and the corresponding HCG, and the left side of which is an EAD subgraph while the right side is the corresponding HCG. Referring again to FIG. 1, when an EAD subgraph is a micro-operation node, it indicates an expression statement or expression processing.

Example 1: as shown in FIG. 3A, the micro-operation node contains an expression statement a=b, and the corresponding HCG is represented by a Q-element. First, a signal req2p is received. Next, a data b is read and stored in a register a to complete the operation of a=b. Next, the register a sends an acknowledgement back to the Q-element, and the Q-element returns a signal ack2p to complete the corresponding HCG.

Example 2: as shown in FIG. 3B, the left side is an EAD subgraph while the right side is the corresponding HCG. The EAD subgraph is a micro-operation node. In this case, the micro-operation node contains an expression statement a=a+b, and the corresponding HCG is represented by a Q-element. First, a signal req2p is received. Next, data b and c is read. Next, an adder (ADD-element) adds b and c and stores the result in a register a to complete the operation of a=b+c. Next, the register a sends an acknowledgement back to the Q-element, and the Q-element returns a signal ack2p to complete the corresponding HCG.

Example 3: as shown in FIG. 3C, if the micro-operation node contains an expression statement sum+=i, the expression statement sum+=i is analyzed to thereby obtain a processing for sum=sum+i, and in this case, two Q-elements are connected to provide two sequential operations, one for an operation temp=sum and the other for a following addition sum=temp+i to thereby complete the processing. Finally, a signal ack2q is returned to complete the corresponding HCG.

Example 4: as shown in FIG. 3D, when the EAD subgraph is a select node, it indicates a determinant instruction. In this case, the determinant instruction contains two conditions, a>b and a<=b, and a decoder-element (D) and a CMP-element are used. The CMP-element compares a and b and accordingly generate two paths, i.e., when a>b (TRUE), an acknowledgement g t4p is sent from one path to the D-element; and when a<=b, another acknowledgement cf4p is sent from the other path to the D-element. Thus, the corresponding HCG is complete.

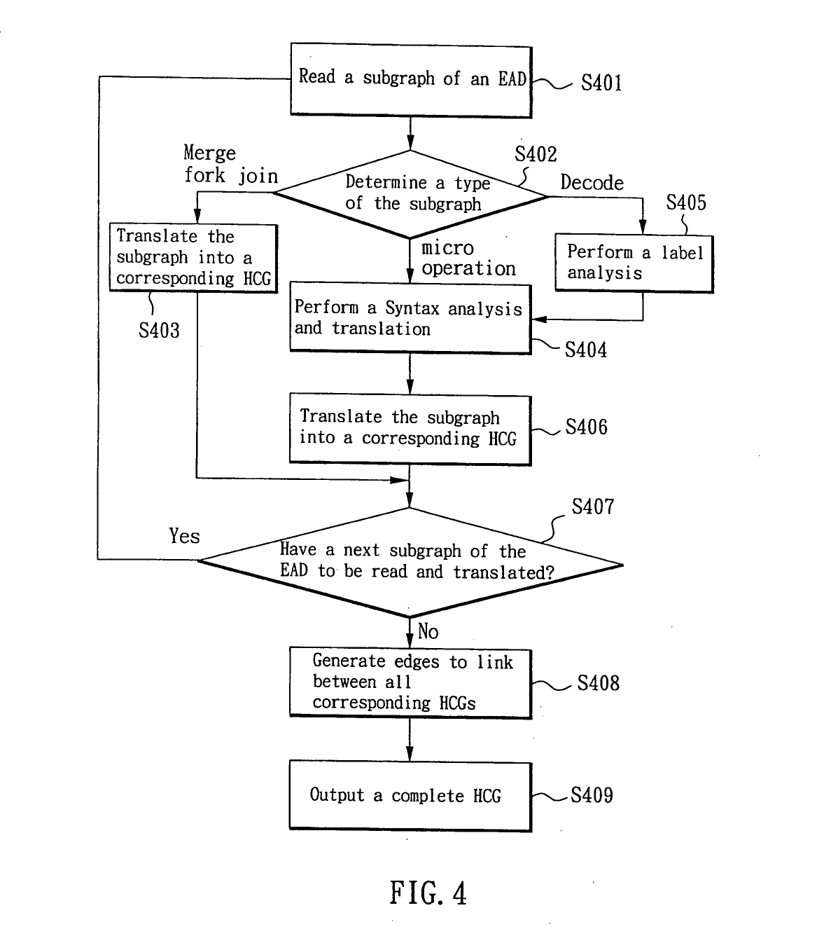

As cited, upon the HCG specification, the EAD can be converted into the corresponding HCG that is more associated with hardware components. FIG. 4 is a flowchart of a process of translating an EAD into an HCG As shown in FIG. 4, step S401 reads a subgraph of the EAD. Step S402 determines a type on the subgraph of the EAD. When a fork, join or merge type is determined, the subgraph of the EAD is translated directly into a corresponding HCG (step S403), and a next subgraph of the EAD is read and translated into a corresponding HCG repeatedly until all subgraphs of the EAD are complete.

When a micro-operation type is determined in step S402, a syntax analysis and translation is performed on the subgraph read, i.e., the micro-operation subgraph (step S404), and accordingly the micro-operation subgraph is translated into a corresponding HCG (step S406). Subsequently, a next subgraph of the EAD is read and translated into a corresponding HCG repeatedly until all subgraphs of the EAD are complete.

When a select type is determined in step S402, the labels on the output ports of obtained corresponding HCGs are analyzed (step S405), and a syntax analysis and translation is performed on the subgraph read, i.e., the select subgraph (step S404). Accordingly, the select subgraph is translated into a corresponding HCG (step S406). Subsequently, a next subgraph of the EAD is read and translated into a corresponding HCG repeatedly until all subgraphs of the EAD are complete (step S40). When all subgraphs of the EAD are complete, edges between input and output ports of all obtained HCGs are generated (step S408) to form a complete HCG, and the complete HCG is output (step S409).

An example is given in a Java program for accumulation as follows.

public class SummationWhile {

public static int sumTo(int cnt) {

int sum = 0, i = 0;
while (i < cnt) {

i++;
sum+=i;

}
return sum;

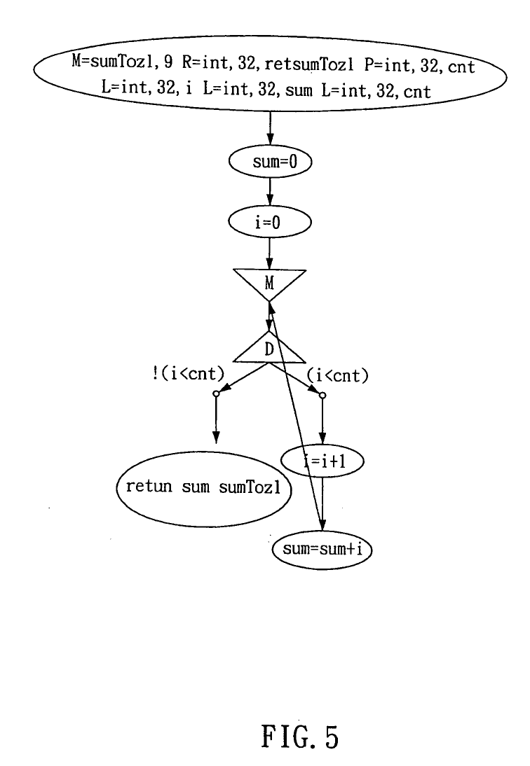

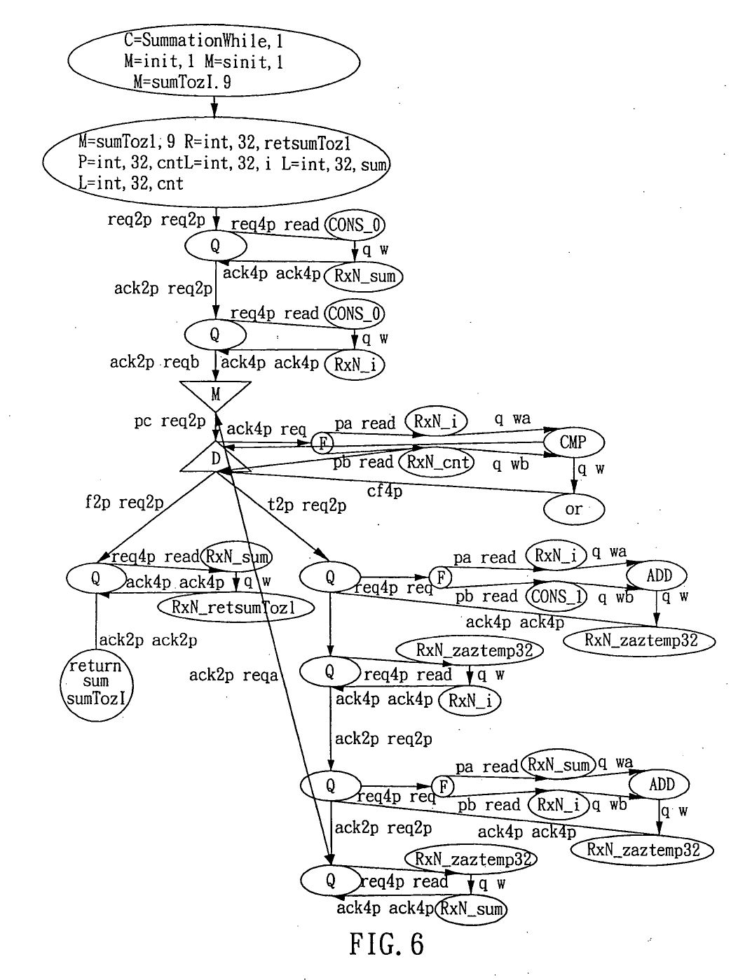

In the example, the Java program is translated into a corresponding EAD shown in FIG. 5, and subsequently the corresponding EAD is translated into a corresponding HCG shown in FIG. 6.

As cited, the process can automatically translate the various source codes of high level programming languages, such as Java, C, C++, etc., into the respective EADs, which are further translated into the respective HCGs that are more associated with hardware components. Thus, the respective hardware description languages (HDL) are generated according to the HCGs to thereby describe the respective high level programming languages.

After the aforementioned translation, the Java program can be translated into a corresponding HCG (as shown in FIG. 6) in which the top node is the start node to record class and method information of the Java program, and the bottom node is the end node to indicate the method end and request a return value. The other nodes in FIG. 6 are labeled to represent the hardware components of register, micro-operation, fork and adder respectively, and a directional edge between the nodes labels from an output port of a source object to an input port of a target object.

Although the present invention has been explained in relation to its preferred embodiment, it is to be understood that many other possible modifications and variations can be made without departing from the spirit and scope of the invention as hereinafter claimed.

What is claimed is:

1. A process of automatically translating an extended activity diagram (EAD) into a hardware component graph (HCG), the EAD consisting of plural subgraphs, the process comprising the steps:
(A) reading a subgraph of the EAD, and executing step (E) when all subgraphs of the EAD is read;
(B) directly translating the subgraph of the EAD into a corresponding HCG when the subgraph of the EAD is determined to be a fork, join or merge type, and executing (A);
(C) performing a syntax analysis and translation on the subgraph of he EAD when the subgraph of the EAD is determined to be a micro-operation type to thus obtain the corresponding HCQ and executing (A);
(D) performing a label analysis first and then a syntax analysis and translation on output ports of obtained corresponding HCGs when the subgraph of the EAD is determined to be a select type, translating the subgraph of the EAD determined to be the select type into the corresponding HCG, and executing step (A); and
(E) linking all participant input and output ports between the corresponding HCGs to output a complete HCG.

2. The process as claimed in claim 1, wherein the EAD comprises eight nodes of start, end, curve point, micro-operation, fork, join, select and merge.

3. The process as claimed in claim 1, wherein the HCG comprises three types of start node, end node, component node.

4. The process as claimed in claim 1, wherein the EAD is defined in a unified modeling language, which is a flow control graph.

5. The process as claimed in claim 1, wherein the HCG indicates a connection relation between hardware components.
